(19) United States
(12) Patent Application Publication
(10) Pub. No.: US 2018/0051185 A1
(43) Pub. Date: Feb. 22, 2018

(54) Pigmented Epoxy Tile and a Method to Fabricate

(71) Applicant: Dante Manarolla, Canton, MI (US)

(72) Inventor: Dante Manarolla, Canton, MI (US)

(21) Appl. No.: 15/239,092

(22) Filed: Aug. 17, 2016

(51) Int. Cl. C09D 163/00; C09D 7/12; E04F 15/08; B05D 3/00; B05D 1/28

(52) U.S. Cl. CPC C09D 163/00; C09D 7/1216; C08K 3/36; B05D 3/007; B05D 1/28; E04F 15/08

(57) ABSTRACT

It is known in the prior art to apply an epoxy coating including a powdered pigment onto commercial and residential floors. However, such an application does not allow the level of control over the process that one may desire. According to the present disclosure, an epoxy (resin and activator) have a powdered pigment mixed in and applied to tiles made of porcelain or other materials. By putting the tile into an oven for a predetermined time, the epoxy polymerizes under controlled conditions. Decorative processes unavailable in an on site application provide effects that are unavailable in direct application to a floor or theoretically any structural horizontal or vertical surface that cannot be manipulated/tilted to achieve the desired decorative design/effect in epoxy pigment. The resulting tiles can also be mounted on walls to provide a look that was completely unavailable using the prior art process of direct application.

### FIELD OF INVENTION

The present disclosure is about tiles for covering surfaces and, in particular pigmented epoxies applied to tiles.

### BACKGROUND

It is known in the prior art application process to coat floors with a pigmented epoxy coating that is made from a resin with an activator that has a powdered pigment mixed in that provides a desired color. Coating the floors on site is fraught with risks. If the flooring has undulations, the coating has non-uniform thickness. Not only does this require applying additional product to get the desired thickness at the highest spot of the floor, it gives an uneven appearance, at least in terms of the color. In the direct application to the floor, there is limited control over environmental factors: temperature, humidity, and dust particles in the air, causing inconsistencies between application, leading to the potential for a floor with noticeable imperfections, reduced durability, customer dissatisfaction, and inconsistencies. This causes particular issues when the surface to be coated is very large and must be covered in sections that may take multiple days.

As is well known in the art, surface preparation is crucial to ensuring adhesion between a solid surface, such as a tile, and a liquid, such as an epoxy, to be applied to the solid surface. The artisan has the ability to sand and/or treat the surface. However, the artisan has limited control over the material of the surface and may know little about the history, e.g., an older concrete, etc. Furthermore, the process is not appropriate over wood unless an epoxy or rigid floor exists

The prior art application process is not known to be applied to vertical structures, i.e., walls, even though such a durable, decorative, attractive coating might be desirable for commercial establishments, such as restaurants, businesses, retail space, hotels, night clubs, theater, stadiums, and residential. The problem lies within the epoxy procured liquid state. Upon application to a vertical surface, the epoxy material does not polymerize fast enough to avoid flowing off the wall creating uneven thickness, color, and visible lines within the material. If the epoxy were made to polymerize faster, therefore addressing the flow of the liquid upon application, it would be difficult to apply the material fast enough resulting in a tacky appearance and ineffective adhesion to the wall.

### SUMMARY

To overcome at least one problem in the prior art application, a process for applying an epoxy coating onto tiles is disclosed herein.

A method to fabricate a tile is disclosed that includes: obtaining an unglazed, unpolished tile, applying a pigmented epoxy onto the unglazed, unpolished tile, and curing the tile at a predetermined temperature for a predetermined time to thereby cause the pigmented epoxy to polymerize on the tile. The pigmented epoxy is comprised of a resin, an activator, and a powdered pigment in predetermined ratios. The predetermined temperature is below the melting temperature of the powdered pigment.

Additionally, the tiles are wiped with a solvent prior to applying the coating. In some embodiments, the tile is sanded prior to wiping the tile with a solvent.

Applying the coating, in some alternatives, includes applying the pigmented epoxy of a first color over the entire tiles and applying a pigmented epoxy having a powdered pigment of a second color mixed therein over a portion of the tile covered by the pigmented epoxy of the first color.

In some alternatives, the pigmented epoxy of a first color is applied over a first portion of the tile and a pigmented epoxy having a powdered pigment of a second color mixed therein is applied over a second portion of the tile.

In some embodiments, the pigmented epoxy is spread on the tile by one of a squeegee, a roller, and a brush.

For some alternatives, a tilt angle of the of the tile is adjusted.

In some embodiments, a solvent is applied onto the pigmented epoxy.

In some applications, a non-skid coating is applied onto the tile after the pigmented epoxy has sufficiently polymerized.

A tile is disclosed that is made of clay, water, and sand that has been fired has at least one pigmented epoxy applied thereto. The pigmented epoxy is made of a mixture of resin, an activator, and a powdered pigment. The resin and activator are provided in a predetermined volumetric ratio. A mass or powdered pigment is added to the resin and activator based on a volume of resin and activator to which the powdered pigment is added. The pigmented epoxy polymerizes at a predetermined temperature for at least a predetermined time. The predetermined temperature is lower than a melting temperature of the powdered pigment.

In some embodiments, the at least one pigmented epoxy comprises a first pigmented epoxy with a powdered pigment of a first color and a second pigmented epoxy with a powdered pigment of a second color.

In some embodiments, the first and second pigmented epoxies are caused to move along the tile by at least one of: tilting the tile, rolling over the tile with a roller, squeegeeing, and brushing.

Some embodiments have a non-skid coating applied over the coating after the pigmented epoxy has sufficiently polymerized.

Polymerization of the pigmented epoxy occurs at atmospheric conditions for at least a first predetermined time and in an oven at a predetermined temperature for a second predetermined time. The predetermined temperature is lower than a melting temperature of the powdered pigment.

A method to fabricate a tile is disclosed that includes: applying a first pigmented epoxy onto at least a first portion of a surface of an unglazed, unpolished tile, applying a second pigmented epoxy onto at least a second portion of the tile, and polymerizing the first and second pigmented epoxies for at least a predetermined time within a predetermined temperature range. The first pigmented epoxy is made of a resin, an activator, and a first powdered pigment. The second pigmented epoxy is made of the resin, the activator, and a second powdered pigment.

The first and second powdered pigments each contain at least one of: titanium dioxide, mica, tin oxide, ammonium manganese pyrophosphate, ultramarine, chromia, ferric ferrocyanide, silica, fluorphlogopite, and calcium aluminum borosilicate.

In some alternatives, the applying a solvent over the first and second pigmented epoxies before significant polymerization has occurred.

The polymerization is accomplished when the tile is kept at ambient condition over a first duration followed by a second duration in which the tile is put into an oven at a temperature in the range of 100 to 150 degrees C. The method further includes removing pigmented epoxy that has flowed over the edges of the tile and the bottom surface of the tile wherein the removing process is accomplished after the first duration and prior to put into the oven.

In some embodiments, the method further includes applying a non-skid coating over the pigmented epoxy after the polymerization is substantially complete.

In some applications, the method also includes tilting the tile to a predetermined angle before significant polymerization has occurred.

An advantage of the disclosed method is that decorative effects that are impossible (like tilting the tile to a desired angle) or difficult (such as, rolling or squeegeeing the epoxy material) in the prior art are rendered trivial when the material is applied to a single tile which can be at or near waist height.

The problem in the prior art of an uneven floor and the pigmented epoxy pooling in low spots is overcome by using a flat tile that can be arranged flat or at a desired angle to allow a desired flow.

By applying the pigmented epoxy in a manufacturing facility, the temperature, humidity, and particulate contamination can be controlled. Furthermore, by putting the tiles in an oven, polymerization is quickened and enhanced. By having the parameters affecting the artistic elements, adhesion, and durability of the resulting pigmented epoxy covering under closer control, great repeatability and quality control are possible than on-site applications. Yet another advantage of the present disclosure is direct applications cannot be made on outdoor surfaces. The epoxied tiles can be made in the manufacturing facility and then applied to an outdoor surface.

The prior art process did not allow pigmented epoxy application to walls. By applying it on tiles, the pigmented epoxy tiles can then be adhered to walls to give a desired durability and desired aesthetic appearance for a wall covering.

If chemicals involved in the process of coating the tiles causes problems for some individuals, by conducting the process in a laboratory or specially-equipped manufacturing site, ventilation and use of standard laboratory paraphernalia: masks, body coverings, gloves, fume hoods, etc. can be employed. Taking such equipment to an installation site is an inconvenience, at best, and next to impossible for other measures. In commercial applications, a direct application of the pigmented epoxy to the floor might be impractical if there are chemicals involved which the employee exposure should be minimized.

An advantage of the disclosed tile and the process to make the tile is that due to the greater control over the application process, a more expansive pallet is available to the tile artist that would be difficult to manage under the prior art direct application to the floor surface.

Yet another advantage is that by applying the pigmented epoxy material onto the tile, the artisan does not need to travel to the site at which the flooring or wall surface is to be installed. Only the tiles are delivered to the site of installation.

The processes disclosed herein are not to be confused with the ancient art of glazing pottery. A ceramic glaze is an impervious layer or coating of a vitreous substance. Often a powder, that might include many of the same materials in the powdered pigment, is mixed into a liquid and painted over the surface of the ceramic or porcelain tile (or other item). The tile is then fired at a temperature in the range of 750-850 degrees C. One of the common fine solids painted on the surface is silica. When fired the silica melts and covers the surface of the tile to provide the impervious surface. In the disclosed process, the curing or polymerization process occurs between the resin and the activator not involving the powdered pigment. Furthermore, the temperature for enhancing polymerization (or curing) is below 150 degrees C., which is well below the firing temperature for the glazing process such that the powdered pigments do not melt. The impervious material in the glazing process is due to the silica, or other material, that melts over the surface. In the disclosed process, the impervious material is made up of the resin and activator which reacts (polymerizes). The heating of the tiles with the pigmented epoxy applied is merely to hasten the process, not strictly necessary because polymerization can be completed at atmospheric conditions over a long period of time. This is in contrast with the glazing of ceramics in which the 750-850 degrees C. firing is necessary to obtain the desired coating.

The pigmented epoxy polymerizes on the tile surface at room temperature over a longer period. The time for near-complete polymerization is shortened significantly by putting the tiles in an oven. The process described herein can be applied to tiles beyond ceramic or porcelain tiles because the temperature in the oven is not that high as it would be in glazing. Wood and laminates can be covered with the pigmented epoxy and put in the oven for quicker polymerization.

### BRIEF DESCRIPTION OF THE DRAWINGS

FIG. 1 is a flowchart indicating processes by which the tiles according to the present disclosure may be fabricated; and

FIG. 2 shows a tile on top of a fixture for holding the tile.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

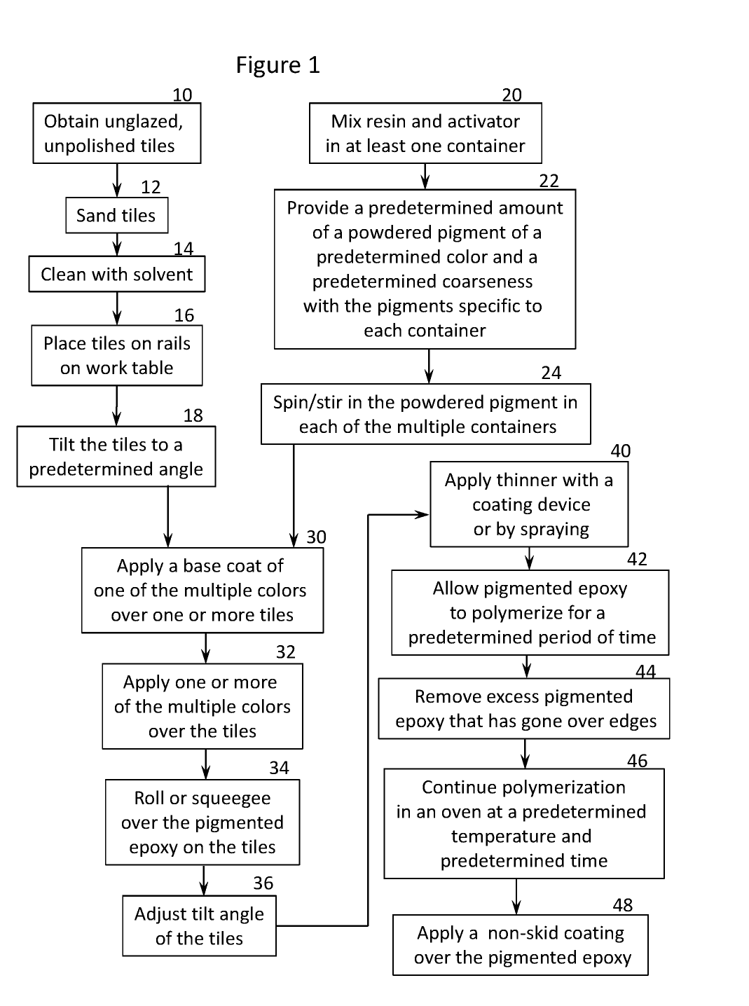

A method to cover a tile is shown in FIG. 1. An unglazed, unpolished tile is purchased or fabricated according to block 10. The tiles may be ceramic or porcelain. In some embodiments, the tiles are of a predetermined color on the surface that is to be coated. The thickness of the tile is greater when it is intended for a floor than those to be applied to a wall. Such tiles are purchased and are commonly available. The fully polymerized pigmented epoxy is brittle. For a floor surface, it is important that the tile onto which it is applied be stiff. If the surface were to flex, such as tiles in a floating floor, it is possible that the pigmented epoxy might crack and chip away. However, there is no such concern for a wall. In this case the epoxy can be applied to a base such as wood, masonite board, interlocking laminate tiles, or any tiles surface. In some cases, the surface of the tile is smoother than desired, in which case, the tiles are sanded to roughen, in block 12. The tiles are cleaned with a solvent, such as acetone or xylene, to remove oil, silicone, or other contaminants that could interfere with the coating process onto the tile, in block 14. The tiles are places on level rails on a work table 16. The work table is not strictly required, however may be useful to bring the tiles to an ergonomically useful height. For many of the desired designs, the tiles are tilted to a predetermined angle so that the liquid coating applied flows to cause some mixing of the colors and travels in a desired direction diagonally, vertically, or horizontally for a desired artistic effect in block 18. The specific angle of the tilt is based on the viscosity of the material applied and the desired artistic effect. Tilting is optional and dependent on the tile design.

In a separate line of activity, a resin and activator are mixed together in a container in block 20. The activities in the following blocks 22, 24, 30, 32, 34, 36, and 40 are accomplished with urgency as once the resin and activator are in contact, polymerization begins, although takes hours to complete. In some embodiments, the tile is treated with a single, solid color, in which case, in block 22, a powdered pigment of the desired color and coarseness is added to the epoxy in the container. In other embodiments, multiple colors are used, in which case, powdered pigments of the desired colors are added to the epoxy material which has been independently mixed into the multiple containers. Alternatively, the epoxy for all of the colors is mixed in one batch and separated into multiple containers for addition of the powdered pigment. All of the desired pigmented epoxies are mixed up in block 24. A predetermined mass of powdered pigment is added based on the amount of epoxy to which the powdered pigment is being added.

In an alternate embodiment, which is particularly useful when a large number of tiles are to made over a period of days, a large batch of resin is mixed with the powdered pigment. Then, a portion of the resin for a single production session is drawn off and mixed with activator. Consequently, the color is consistent throughout the production process for that order.

In another alternative, a two-part polyurethane is used as the resin and activator.

In single-color embodiments, the pigmented epoxy is applied to the entire surface of the tile, in block 30. In other embodiments, a base coat, that is intended to have other colors applied over the base coat is applied over the entire tile in block 30. In embodiments with multiple colors, the other pigmented epoxies are placed on the tiles in block 32. In some embodiments, the top colors are placed over discrete portions of the tile. In other embodiments, one or more colors of the pigment are applied via an opening in a funnel or other container to provide decorative lines over other pigmented epoxy. With some designs, it is desirable to spread the colors on to the tile by rolling, squeegeeing, brushing, or using compressed air the pigmented epoxies to achieve the desired appearance in block 34. In embodiments with only one color, one or more of the rolling, squeegeeing, brushing, and using compressed air can be used to affect the surface finish. In some embodiments, the tilt of the tiles is adjusted in block 36. In block 40, a thinner, acetone and xylene being non-limiting examples, is sprayed on or coated over the pigmented epoxy on the tile. Such thinner causes the colors to run together and affects the surface finish. Any suitable solvent may be used, included, but not limited to: naphtha, toluene, mineral spirits, alcohols, turpentine, and methyl ethyl ketone.

In block 42, the pigmented epoxy is allowed to cure or polymerize at ambient conditions for a predetermined period of time; the production facility can be provided with climate control for production consistency. The predetermined time is long enough so that the pigmented epoxy is hard to the touch. During the process of putting the pigmented epoxy on the tiles, some of the pigmented epoxy runs over the edges. The slopping over the edges and sometimes even on the bottom of the tile happens to a greater degree when the tile is tilted. At this point, it is possible to remove the excess material with a sharp metal edge, a spatula, a putty knife, or any suitable tool, shown in block 44. If the pigmented epoxy were to polymerize well beyond the hard to the touch level, the material that has gotten onto the edges could not be removed by a spatula. Instead, a grinder, a file, or other machine tool is needed when the pigmented epoxy has become significantly hardened through polymerization.

The tiles would cure in about six days if allowed to polymerize at ambient conditions. Such a length of time is inconsistent with a production process. After the excess product is removed from the tiles, they can be placed in an oven, in block 46, at a predetermined temperature and a predetermined time. The temperature is in the range of about 100 to 150 degrees C. and may vary depending on the pigmented epoxies used. The time used is in the 2-10 hour range again depending on the epoxies and how long the pigmented epoxy is allowed to polymerize at ambient conditions prior to the oven polymerization. It is well-known by those skilled in the art that chemical reactions, such as the polymerization of the resin, is markedly increased when temperature is raised. For a production facility, it is important to increase the output, which polymerization at an elevated temperature in an oven allows.

For some floor applications, particularly in commercial applications, a non-skid surface finish is desired. After the tiles are removed from the oven and allowed to cool down, a non-skid coating is applied in block 48. A static coefficient of friction (SCOF) for a non-skid floor is 0.5 or higher. The non-skid product can be applied to give a SCOF of 0.6 for flat applications and increased to at least 0.8 for ramp applications.

Some of the processes in FIG. 1 are optional. Furthermore, some of the processes can be performed in an alternative order than that illustrated in FIG. 1. And, as described above, there are alternative embodiments for some of the processes that also fall within the scope of the disclosure.

The tiles are an artistic craft. The number of colors of the powdered pigments is extensive. A typical design uses three colors. Adding further to the options are the tilt angle, compressed air the application of a thinner, the coarseness of the powdered pigment, etc. The options are nearly infinite.

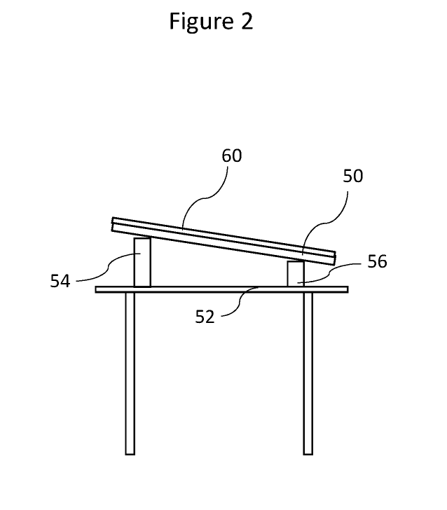

Referring now to FIG. 2, a tile 50 is shown sitting on a table 52 propped up by a shorter rail 56 and a taller rail 54. Pigmented epoxy 60 is on the surface of tile 50. Because tile 50 is tilted, before the pigmented epoxy 60 is polymerized, the pigmented epoxy 60 may flow off the tile over the edge of the tile and drip onto the table.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

1. A method to fabricate a tile, comprising:
obtaining an unglazed, unpolished tile;
applying a pigmented epoxy onto the unglazed, unpolished tile; and
curing the tile at a predetermined temperature for a predetermined time to thereby cause the pigmented epoxy to polymerize on the tile; wherein:
the pigmented epoxy is comprised of a resin, an activator, and a powdered pigment in predetermined ratios; and
the predetermined temperature is below the melting temperature of the powdered pigment.

2. The method of claim 1, further comprising: wiping the tile with a solvent prior to applying the coating.

3. The method of claim 1, further comprising: sanding the tile prior to wiping the tile with a solvent.

4. The method of claim 1 wherein the applying the coating comprises:
applying the pigmented epoxy of a first color over the entire tile; and
applying a pigmented epoxy having a powdered pigment of a second color mixed therein over a portion of the tile covered by the pigmented epoxy of the first color.

5. The method of claim 1 wherein the applying the coating comprises:
applying the pigmented epoxy of a first color over a first portion of the tile; and
applying a pigmented epoxy having a powdered pigment of a second color mixed therein over a second portion of the tile.

6. The method of claim 1, further comprising: spreading the pigmented epoxy on the tile by one of a squeegee, a roller, and a brush.

7. The method of claim 1, further comprising: adjusting a tilt angle of the tile.

8. The method of claim 1, further comprising: applying a solvent onto the pigmented epoxy.

9. The method of claim 1, further comprising: applying a non-skid coating onto the tile after the pigmented epoxy has sufficiently polymerized.

10. A tile, comprising:
a tile comprised of clay, water, and sand that has been fired; and
at least one pigmented epoxy applied to the tile wherein:
the pigmented epoxy is comprised of a mixture of resin, an activator, and a powdered pigment;
the resin and activator are provided in a predetermined volumetric ratio;
a mass or powdered pigment is added to the resin and activator based on a volume of resin and activator to which the powdered pigment is added;
the pigmented epoxy polymerizes at a predetermined temperature for at least a predetermined time; and
the predetermined temperature is lower than a melting temperature of the powdered pigment.

11. The tile of claim 10 wherein:
the at least one pigmented epoxy comprises a first pigmented epoxy with a powdered pigment of a first color and a second pigmented epoxy with a powdered pigment of a second color.

12. The tile of claim 11 wherein the first and second pigmented epoxies are caused to move along the tile by at least one of: tilting the tile, rolling over the tile with a roller, squeegeeing, and brushing.

13. The tile of claim 10, further comprising: a non-skid coating applied over the coating after the pigmented epoxy has sufficiently polymerized.

14. The tile of claim 10 wherein polymerization is accomplished by:
polymerization of the pigmented epoxy at atmospheric conditions for at least a first predetermined time; and
polymerization of the pigmented epoxy in an oven at a predetermined temperature for a second predetermined time wherein the predetermined temperature is lower than a melting temperature of the powdered pigment.

15. A method to fabricate a tile, comprising:
applying a first pigmented epoxy onto at least a first portion of a surface of an unglazed, unpolished tile;
applying a second pigmented epoxy onto at least a second portion of the tile; and
polymerizing the first and second pigmented epoxies for at least a predetermined time within a predetermined temperature range wherein: the first pigmented epoxy is comprised of a resin, an activator, and a first powdered pigment; and the second pigmented epoxy is comprised of the resin, the activator, and a second powdered pigment.

16. The method of claim 15 wherein the first and second powdered pigments each contain at least one of: titanium dioxide, mica, tin oxide, ammonium manganese pyrophosphate, ultramarine, chromia, ferric ferrocyanide, silica, fluorphlogopite, and calcium aluminum borosilicate.

17. The method of claim 15, further comprising:
applying a solvent over the first and second pigmented epoxies before significant polymerization has occurred.

18. The method of claim 15 wherein the polymerization is accomplished when the tile is kept at ambient condition over a first duration followed by a second duration in which the tile is put into an oven at a temperature in the range of 100 to 150 degrees F., further comprising:
removing pigmented epoxy that has flowed over the edges of the tile and the bottom surface of the tile wherein the removing process is accomplished after the first duration and prior to put into the oven.

19. The method of claim 15, further comprising:
applying a non-skid coating over the pigmented epoxy after the polymerization is substantially complete.

20. The method of claim 15, further comprising: tilting the tile to a predetermined angle before significant polymerization has occurred.
